(19) United States
(12) Patent Application Publication
(10) Pub. No.: US 2006/0085279 A1
(43) Pub. Date: Apr. 20, 2006

(54) Cartridge ordering management method and apparatus

(76) Inventor: Sang-jin Lee, Suwon-si (KR)

Correspondence Address: STANZIONE & KIM, LLP, 919 18TH STREET, N.W., SUITE 440, WASHINGTON, DC, 20006, US

(21) Appl. No.: 11/229,674

(22) Filed: Sep. 20, 2005

(30) Foreign Application Priority Data
Oct. 4, 2004 (KR) 2004-78738

(51) Int. Cl. G06Q 30/00; G03G 15/00

(52) U.S. Cl. 705/26; 347/7; 347/19; 399/24

(57) ABSTRACT

A cartridge ordering management apparatus and method usable with an image forming apparatus. The method includes: managing cartridge order information which includes cartridge identification of each cartridge to be ordered, and generating order request information of cartridges to be ordered using the cartridge order information and transmitting the order request information to a cartridge provider. Accordingly, it is possible to allow a number and type of desired cartridges to be automatically determined and the desired cartridges to be automatically ordered when toner in cartridges installed in the image forming apparatus is consumed. Thus, a user can conveniently use and manage the image forming apparatus.

### CROSS-REFERENCE TO RELATED APPLICATIONS

This application claims priority from Korean Patent Application No. 2004-78738, filed on Oct. 4, 2004, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to a method and apparatus to effectively manage ordering of cartridges when toner contained in the cartridges of an image forming apparatus is consumed.

2. Description of the Related Art

Conventionally, when toner in a cartridge of an image forming apparatus is exhausted, a user replaces the cartridge with a new cartridge or places an order for a new cartridge from a cartridge provider. To remove the inconvenience of requiring a user to order the new cartridge, image forming apparatuses have recently been manufactured to include a feature that automatically places an order for a new cartridge from a cartridge provider when the toner in the cartridge of the image forming apparatus is consumed.

However, this automatic feature only places an automatic order and can not provide the cartridge provider with the number or type of desired cartridge. Accordingly, the user must provide such information to the cartridge provider.

Additionally, when the automatic feature is deactivated, it is impossible to count the total number of cartridges in which toner is consumed, thereby preventing effective management of the ordering of new cartridges.

### SUMMARY OF THE INVENTION

The present general inventive concept provides a cartridge ordering management method to automatically manage a type and number of desired cartridges and to place an order for the desired cartridges.

The present general inventive concept also provides a cartridge ordering management apparatus to automatically manage a type and number of desired cartridges and to place an order for the desired cartridges.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a cartridge ordering management method, the method comprising managing cartridge order information that includes cartridge identification of each cartridge to be ordered, and generating order request information of the cartridges to be ordered and transmitting the generated order request information of the cartridges to be ordered to a cartridge provider.

The foregoing and/or other aspects of the present general inventive concept are also achieved by providing a cartridge ordering management apparatus, comprising an order information managing unit to manage cartridge order information including cartridge identification information of each cartridge to be ordered, and an order request information transmitting unit to transmit order request information of the cartridges to be ordered, which is generated using the cartridge order information, to a cartridge provider.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a flowchart illustrating a cartridge ordering management method according to an embodiment of the present general inventive concept;

FIG. 2 illustrates cartridge order information managed in operation 10 of the cartridge ordering management method of FIG. 1;

FIG. 3 illustrates order display information managed in operation 10 of the cartridge ordering management method of FIG. 1;

FIG. 4 is a detailed flowchart illustrating operation 10 of the cartridge ordering management method of FIG. 1;

FIG. 5 is a detailed flowchart illustrating operation 12 of the cartridge ordering management method of FIG. 1;

FIG. 6 is a block diagram illustrating a cartridge ordering management apparatus according to an embodiment of the present general inventive concept;

FIG. 7 is a detailed block diagram illustrating an order information managing unit of the cartridge ordering management apparatus of FIG. 6; and

FIG. 8 is a detailed block diagram illustrating an order request information transmitting unit of the cartridge ordering management apparatus of FIG. 6.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

FIG. 1 is a flowchart illustrating a cartridge ordering management method according to an embodiment of the present general inventive concept. The cartridge ordering management method may be used with an image forming apparatus. Referring to FIG. 1, cartridge order information, including respective cartridge identification information that identifies cartridges to be ordered and order display information indicating that the cartridge identification information is stored among optional cartridge order information, is managed (operation 10).

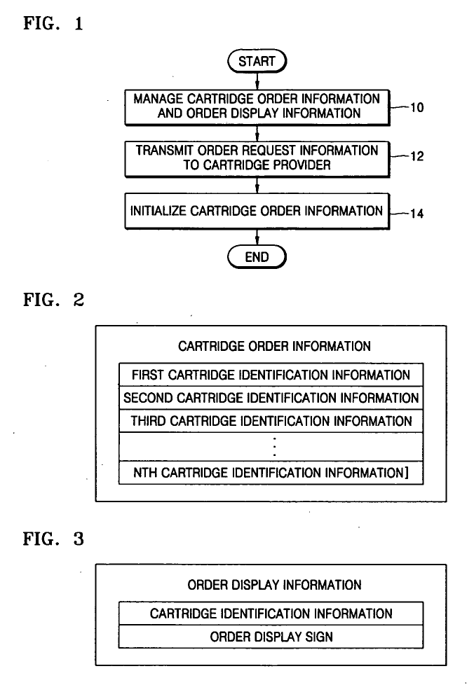

The cartridge order information contains the cartridge identification information regarding each of the cartridges to be ordered. FIG. 2 illustrates an example of the cartridge order information explained in operation 10 of FIG. 1. Referring to FIG. 2, the cartridge order information includes first through N^{th} cartridge identification information regarding first through N^{th} cartridges (N is a positive integer greater than 1). The cartridge order information may be stored in either a memory which is a predetermined storage space of an information forming apparatus, or a cartridge.

The order display information, which is used to order a new cartridge, indicates that the cartridge identification information that identifies a cartridge in which toner is exhausted is stored among the optional cartridge order information.

The new cartridge that is ordered may be used to replace the cartridge in which toner is exhausted. The new cartridge may be ordered when toner is partially or entirely exhausted. For example, the new cartridge may be ordered when a toner amount in the cartridge of the image forming apparatus decreases below a predetermined level.

FIG. 3 illustrates an example of the order display information managed in operation 10 of FIG. 1. Referring to FIG. 3, the order display information contains cartridge identification information and an order display sign. For instance, when the order display sign is displayed, it can be determined that the cartridge identification information that identifies a cartridge to be ordered (e.g., the cartridge in which toner is exhausted) is included in cartridge order information stored in the image forming apparatus. Thus, the order display information may be displayed to indicate the cartridges to be ordered. For example, the order display information may be displayed to a user on a display unit using the order display sign. The order display information indicates the cartridge identification information that identifies the cartridges to be ordered such that the user can determine whether to proceed with an order request for the cartridges identified by the order display information.

Order request information, which is described in detail below, specifies a total number of cartridges of each type to be ordered. The order request information is obtained by categorizing cartridges according to type based on the cartridge identification information included in the cartridge order information and counting the total number of the cartridges of each type.

In operation 10, the cartridge order information and the order display information are managed. In particular, the cartridge order information and the order display information can be stored and/or updated.

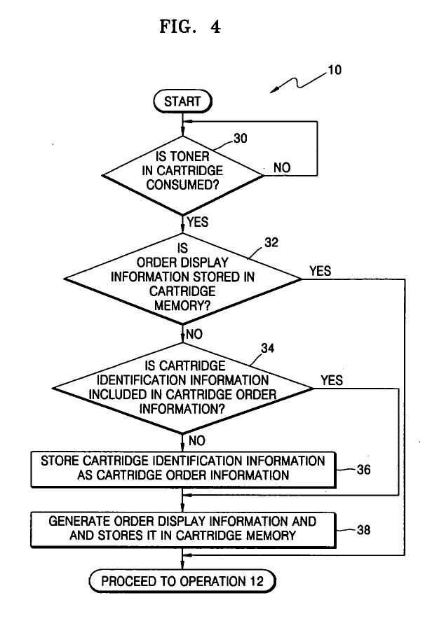

FIG. 4 is a detailed flowchart illustrating operation 10 of FIG. 1. Referring to FIG. 4, it is determined whether toner in each cartridge installed in the image forming apparatus is consumed (operation 30). That is, amounts of toner in the cartridges which are currently being used or are newly installed are checked. The amounts of toner may be repeatedly and/or periodically checked.

However, when it is determined that the toner in a cartridge is consumed, it is determined whether the order display information that corresponds to the consumed cartridge is stored in a cartridge memory of the corresponding consumed cartridge (operation 32). When the order display information is stored in the cartridge memory of the corresponding consumed cartridge, it is determined that cartridge identification information that identifies the corresponding consumed cartridge has been included in the cartridge order information stored in the image forming apparatus.

The cartridges used by the image forming apparatus may include a cartridge memory, which is a storage space in the cartridge that stores information regarding the cartridge, e.g., the cartridge identification information, a number of sheets of paper on which an image is formed, and information regarding a cartridge manufacturer/provider. The cartridge memory may be included in a customer replacement unit monitor (CRUM).

If the order display information of the corresponding consumed cartridge is not stored in the cartridge memory thereof, it is determined whether the cartridge identification information that identifies the consumed cartridge is included in the cartridge order information stored in the image forming apparatus (operation 34). For instance, it is determined in operation 34 whether the cartridge identification information that identifies the corresponding consumed cartridge is included in the cartridge order information illustrated in FIG. 2. When the order display information of the corresponding consumed cartridge is not stored in the cartridge memory, it is determined that the cartridge identification information that identifies the corresponding consumed cartridge is not stored in the image forming apparatus.

If the cartridge identification information that identifies the corresponding consumed cartridge is included in the cartridge order information, the method proceeds to operation 38, which is described below. When the cartridge identification information that defines the corresponding consumed cartridge is included in the cartridge order information, it is determined that an order has been made for the corresponding consumed cartridge identified by the cartridge identification information. In other words, a replacement cartridge for the corresponding consumed cartridge is to be ordered with a next order request that is sent to a cartridge provider.

However, when the cartridge identification information that identifies the corresponding consumed cartridge is not included in the cartridge order information, the cartridge identification information is stored as the cartridge order information (operation 36). Thus, the corresponding consumed cartridge identified by the cartridge identification information is categorized as a cartridge to be ordered such that the replacement cartridge for the corresponding consumed cartridge can be ordered with the next order request sent to the cartridge provider.

The cartridge order information may be stored in a memory of the image forming apparatus. Alternatively, the cartridge order information may be stored in an external memory cartridge.

Once the cartridge identification information that identifies the corresponding consumed cartridge is stored as the cartridge order information at operation 36, the order display information of the corresponding consumed cartridge is generated and stored in the cartridge memory (operation 38). An example of the order display information is illustrated in FIG. 3. When the order display information is stored in the cartridge memory of the corresponding consumed cartridge, a replacement cartridge for the corresponding consumed cartridge is to be ordered with the next order request.

Referring to FIG. 1, once the cartridge order information and order display information of the cartridges are managed at operation 10, the order request information is generated using the cartridge order information and is then transmitted to a cartridge provider (operation 12). Since the cartridge order information includes the cartridge identification information regarding each cartridge being ordered, the order request information is obtained by classifying the cartridges being ordered according to type and counting the number of the cartridges being ordered of each type. The obtained order request information is then transmitted to the cartridge provider over a network. It should be understood that the embodiments of the present general inventive concept may be used with a plurality of cartridge providers that provide different types of cartridges.

FIG. 5 is a detailed flowchart illustrating operation 12 of FIG. 1. Referring to FIG. 5, it is determined whether an order request for a cartridge for an image forming apparatus is received (operation 50). The order request may be placed and sent by a user. For example, the user may place an order request for a cartridge from a cartridge provider over a network by inputting an order command to the image forming apparatus. Whether an order request for a cartridge for the image forming apparatus is received by the image forming apparatus may be periodically determined at operation 50.

If the user inputs the order command to the image forming apparatus, it is determined whether cartridge order information is present (operation 52). That is, when the user inputs the order command to the image forming apparatus, it is determined whether the cartridge order information is stored in the image forming apparatus.

If the cartridge order information is not stored in the image forming apparatus, the method proceeds to operation 56, which is described below.

When the cartridge order information is stored in the image forming apparatus, the order request information is obtained by detecting the type and number of cartridges to be ordered from the cartridge order information (operation 54). In particular, when the cartridge order information is present (i.e., stored in the image forming apparatus), the order request information is obtained by categorizing the cartridges to be ordered according to type based on each cartridge identification information included in the cartridge order information and counting the number of the cartridges to be ordered of each type.

Once the order request information is generated at operation 54, the order request information is transmitted to the cartridge provider (operation 56). The image forming apparatus and the cartridge provider may be connected via a wire/wireless network such that the image forming apparatus and the cartridge provider can communicate with each other. Thus, the order request information can be transmitted to the cartridge provider via the network.

If it is determined in operation 52 that the cartridge order information is not present (i.e., is not stored in the image forming apparatus), the order request information regarding only the cartridges installed in the image forming apparatus is obtained and transmitted to the cartridge provider.

The cartridge provider receives the order request information, determines the type and number of cartridges to be ordered, and provides the user with the ordered cartridges.

As illustrated in FIG. 1, once the order request information is transmitted to the cartridge provider at operation 12, the cartridge order information is initialized (operation 14). Specifically, when the order request information is sent to the cartridge provider, it is determined that an order of cartridges specified by the cartridge order information has been transmitted to the cartridge provider. Thus, the cartridge order information is initialized to prevent the cartridges from being redundantly ordered. New cartridge identification information is included in the initialized cartridge order information.

A cartridge ordering management apparatus according to an embodiment of the present general inventive concept will now be described.

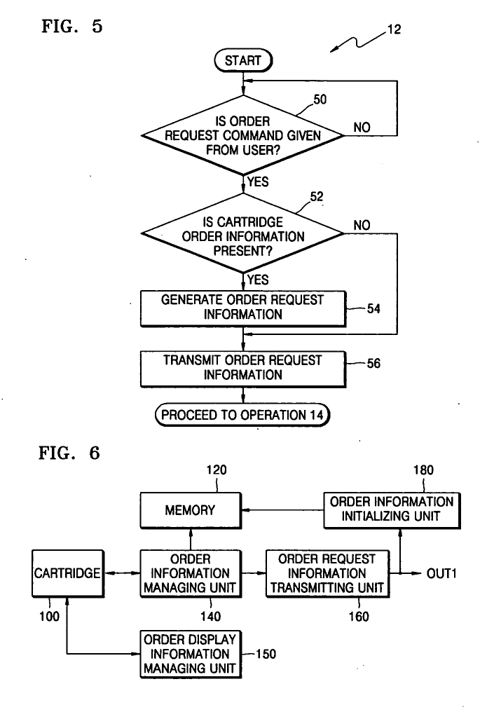

FIG. 6 is a block diagram illustrating a cartridge ordering management apparatus according to an embodiment of the present general inventive concept. The apparatus includes a cartridge 100, a memory 120, an order information managing unit 140, an order display information managing unit 150, an order request information transmitting unit 160, and an order information initializing unit 180.

The cartridge 100 includes toner and a cartridge memory (not shown). It should be understood that the cartridge 100 of the cartridge ordering management apparatus may include a plurality of cartridges. The cartridge memory stores information regarding the cartridge 100, e.g., cartridge identification information, the number of sheets of paper on which an image is formed, and information regarding a cartridge manufacturer/provider. The cartridge memory may store order display information which is described below.

The memory 120 may comprise an information storage space in the image forming apparatus.

The order information managing unit 140 manages cartridge order information including cartridge identification information of each cartridge to be ordered. As described above, an example of the cartridge order information is illustrated in FIG. 2.

The cartridge order information may be stored in the memory 120, which may be installed in an image forming apparatus (not shown), or an external memory cartridge.

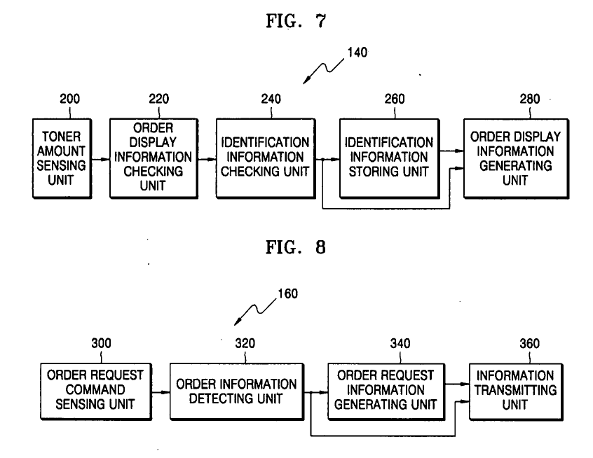

FIG. 7 is a detailed block diagram illustrating the order information managing unit 140 of FIG. 6. Referring to FIG. 7, the order information managing unit 140 includes a toner amount sensing unit 200, an order display information checking unit 220, an identification information checking unit 240, an identification information storing unit 260, and an order display information generating unit 280.

The toner amount sensing unit 200 determines whether toner of the cartridge 100 is consumed and transmits a result of the determination to the order display information checking unit 220.

When the result of the determination output from the toner amount sensing unit 200 indicates that the toner in the cartridge 100 is consumed, the order display information checking unit 220 checks whether order display information is stored in the cartridge memory (not shown) of the cartridge 100 and transmits a result of the check to the identification information checking unit 240. The order display information indicates that cartridge identification information of the cartridge 100 is stored in the memory 120 with the cartridge order information.

When the order display information is stored in the cartridge memory, it is determined that the cartridge identification information that identifies the cartridge 100 has been stored in the memory 120 with the cartridge order information to place an order request for the cartridge 100. As described above, FIG. 3 illustrates an example of order display information that includes cartridge identification information and an order display sign.

If the result of the check of the order display information checking unit 220 indicates that the order display information is not stored in the cartridge memory, the identification information checking unit 240 checks whether the cartridge identification information that identifies the cartridge 100 is included in the cartridge order information stored in the memory 120 and transmits the result of the check to the identification information storing unit 260 and the order display information generating unit 280. For instance, the identification information checking unit 240 checks whether the cartridge order information includes the cartridge identification information of the cartridge 100. When the order display information is not stored in the cartridge memory of the cartridge 100, the identification information checking unit 240 determines that the cartridge identification information that identifies the cartridge 100, and which is used to order the cartridge 100, is not stored in the memory 120.

When the result of the check that is transmitted by the identification information checking unit 240 indicates that the cartridge identification information that identifies the cartridge 100 is not included in the cartridge order information, the identification information storing unit 260 stores the cartridge identification information as cartridge order information in the memory 120 and outputs the result of the storage to the order display information generating unit 280.

When the result of the check that is transmitted by the identification information checking unit 240 or the result of the storage is transmitted from the identification information storing unit 260 indicates that the cartridge identification information that identifies the cartridge 100 is included in the cartridge order information, the order display information generating unit 280 generates the order display information regarding the cartridge 100 and stores the order display information in the cartridge memory of the cartridge 100. An example of the order display information is illustrated in FIG. 3. When the order display information is stored in the cartridge memory, the cartridge 100 specified by the order display information is ordered with an order request.

The order display information managing unit 150 manages storing of the order display information in the cartridge memory of the cartridge 100 and updating of the order display information.

The order request information transmitting unit 160 transmits the order request information generated using the cartridge order information to the cartridge provider via an output terminal OUT1, and also transmits the cartridge order information to the order information initializing unit 180.

FIG. 8 is a detailed block diagram illustrating the order request information transmitting unit 160 of FIG. 6. Referring to FIG. 8, the order request information transmitting unit 160 includes an order request command sensing unit 300, an order information detecting unit 320, an order request information generating unit 340, and an information transmitting unit 360.

The order request command sensing unit 300 determines whether a command to order the cartridge 100 is received and outputs the result of the determination to the order information detecting unit 320. For example, the order request command sensing unit 300 may determine whether an order command is input by a user.

When the result of the determination indicates that the order command is received, the order information detecting unit 320 determines whether cartridge order information is present (i.e., is stored in the memory 120) and outputs the result of the determination to the order request information generating unit 340.

When the result of the determination transmitted by the order information detecting unit 320 indicates that the cartridge order information is present (i.e., is stored in the memory 120), the order request information generating unit 340 detects the type and number of cartridges to be ordered according to the cartridge order information, generates the order request information, and outputs the order request information to the information transmitting unit 360. The order request information generating unit 340 categorizes the cartridges according to type based on each cartridge identification information included in the cartridge order information stored in the memory 120, and generates the order request information by counting the number of the cartridges of each type.

Upon receipt of the order request information from the order request information generating unit 340, the information transmitting unit 360 transmits the order request information to the cartridge provider over a wire/wireless network. The information transmitting unit 360 may be connected to the cartridge provider via the wire/wireless network such that the information transmitting unit 360 can communicate with the cartridge provider.

When the result of the determination transmitted by the order information detecting unit 320 indicates that the cartridge order information is not present (i.e., is not stored in the memory 120), the information transmitting unit 360 generates the order request information regarding only the cartridge 100 and transmits the order request information to the cartridge provider over the wire/wireless network.

Upon receipt of the order request information from the order request information transmitting unit 160, the order information initializing unit 180 outputs a control signal to the memory 120 to initialize the cartridge order information. The cartridge order information stored in the memory 120 is then initialized accordingly.

The embodiments of the present general inventive concept can be embodied in software, hardware, or a combination thereof. In particular, some embodiments can be computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, DVDs, etc.), and storage media such as carrier waves (e.g., transmission through the internet). The computer readable recording medium can also be distributed over network coupled computer systems so that the computer programs are stored and executed in a distributed manner.

As described above, a cartridge ordering management method and apparatus according to the present general inventive concept allow a number and type of desired cartridges to be automatically determined and the desired cartridges to be automatically ordered when toner in cartridges of an image forming apparatus is consumed, thereby allowing a user to conveniently use and manage the image forming apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of managing ordering of cartridges in an image forming apparatus, the method comprising:
managing cartridge order information that includes cartridge identification of each cartridge to be ordered; and
generating order request information of cartridges to be ordered using the cartridge order information and transmitting the order request information to a cartridge provider.

2. The method of claim 1, further comprising:
managing order display information which indicates that the cartridge identification information is included in the cartridge order information.

3. The method of claim 1, wherein the managing of the cartridge order information comprises:
detecting whether toner in a cartridge installed in the image forming apparatus is consumed;
determining whether the cartridge identification information that identifies the installed cartridge is included in the cartridge order information when the toner in the installed cartridge is consumed; and
storing the cartridge identification information that identifies the installed cartridge as the cartridge order information when the cartridge identification information is not included in the cartridge order information.

4. The method of claim 1, wherein the managing of the cartridge order information comprises:
determining whether toner in a cartridge installed in the image forming apparatus is consumed;
determining whether order display information, which indicates that the cartridge identification information that identifies the installed cartridge is included in the cartridge order information, is stored in a cartridge memory of the installed cartridge when the toner in the installed cartridge is determined to be consumed;
determining whether the cartridge identification information that identifies the installed cartridge is included in the cartridge order information when the toner in the installed cartridge is consumed when the order display information is not stored in the cartridge memory; and
storing the cartridge identification information that identifies the installed cartridge as the cartridge order information when the cartridge identification information that identifies the installed cartridge is not included in the cartridge order information.

5. The method of claim 4, wherein the managing of the cartridge order information further comprises:
generating the order display information of the installed cartridge and storing the order display information in the cartridge memory of the installed cartridge when the order display information is not stored in the cartridge memory.

6. The method of claim 1, wherein the generating of the order request information of the cartridges comprises:
determining whether an order request command for the cartridges is received;
determining whether the cartridge order information is stored in a predetermined memory when the order request command is received;
detecting a type and a number of the cartridges to be ordered from the cartridge order information and generating the order request information when the cartridge order information is stored in the predetermined memory; and
transmitting the generated order request information to the cartridge provider.

7. The method of claim 1, further comprising:
initializing the cartridge order information in the predetermined memory.

8. A method of managing orders for replacement cartridges in an image forming apparatus, the method comprising:
determining whether at least one cartridge in the image forming apparatus should be replaced;
reading identification information about the at least one cartridge from at least one cartridge memory associated with the at least one cartridge; and
compiling an order request having identification information about each of the at least one cartridge that should be replaced.

9. The method of claim 8, further comprising:
transmitting the compiled order request to a cartridge provider.

10. The method of claim 8, wherein the compiling of the order request having the identification information about each of the at least one cartridge that should be replaced comprises:
determining whether a list of cartridges to be ordered is stored in a memory associated with the image forming apparatus;
generating the order request accordingly when the list of cartridges to be ordered is stored in the memory associated with the image forming apparatus; and
transmitting the order request to a cartridge provider.

11. The method of claim 10, wherein the generating of the order request comprises categorizing cartridges on the list of cartridges to be ordered according to a cartridge type and counting a number of each cartridge type to be ordered.

12. The method of claim 8, wherein the compiling of the order request having the identification information about each of the at least one cartridge that should be replaced comprises storing a list of identification information of cartridges having toner that is consumed in a memory associated with the image forming apparatus.

13. The method of claim 12, wherein the compiling of the order request having the identification information about each of the at least one cartridge that should be replaced further comprises:
determining whether order display information that corresponds to the at least one cartridge that should be replaced is stored in the corresponding at least one cartridge memory;
determining whether the identification information of the at least one cartridge that should be replaced is included in the list of identification information of cartridges having toner that is consumed when the order display information is not stored in the corresponding at least one cartridge memory; and
storing the identification information about each of the at least one cartridge that should be replaced in the list of identification information of cartridges having toner that is consumed when the identification information of the at least one cartridge that should be replaced is not included in the list of identification information of cartridges having toner that is consumed.

14. A method of automatically managing cartridge replacement orders, the method comprising:
pre-storing a plurality of cartridge identification information in a plurality of cartridge memories of a plurality of cartridges; and
determining one or more cartridges that are low on toner;
enabling the cartridge identification information of the determined one or more cartridges that are low on toner to be read from corresponding one or more cartridge memories; and
transmitting an order request for one or more replacement cartridges including cartridge identification information read from the one or more cartridge memories of the one or more cartridges that are low on toner.

15. The method of claim 14, wherein the transmitting of the order request comprises transmitting the order request to a cartridge provider over a network.

16. An apparatus to manage ordering cartridges usable with an image forming apparatus, comprising:
an order information managing unit to manage cartridge order information including cartridge identification information of each cartridge to be ordered; and
an order request information transmitting unit to transmit order request information of cartridges to be ordered, which is generated using the cartridge order information, to a cartridge provider.

17. The apparatus of claim 16, further comprising:
an order display information managing unit to manage order display information which indicates that the cartridge identification information that identifies the cartridges to be ordered is included in the cartridge order information.

18. The apparatus of claim 16, wherein the order information managing unit comprises:
a toner amount sensing unit to determine whether toner in a cartridge installed in the image forming apparatus is consumed;
an identification information checking unit to receive a result of the determination output by the toner amount sensing unit and to check whether the cartridge identification information that identifies the installed cartridge is included in the cartridge order information; and
an identification information storing unit to receive a result of the check output from the identification information checking unit and to store the cartridge identification information that identifies the installed cartridge as the cartridge order information.

19. The apparatus of claim 18, wherein the order information managing unit further comprises:
an order display information checking unit to receive the result of the determination output from the toner amount sensing unit and to check whether order display information that corresponds to the installed cartridge, which indicates that the cartridge identification information that identifies the installed cartridge is included in the cartridge order information, is stored in a cartridge memory of the installed cartridge.

20. The apparatus of claim 19, wherein the order information managing unit further comprises:
an order display information generating unit to generate the order display information of the cartridges to be ordered and to store the generated order display information in corresponding cartridge memories.

21. The apparatus of claim 16, wherein the order request information transmitting unit comprises:
an order request command sensing unit to determine whether an order request command for ordering the cartridges is received;
an order information detecting unit to receive a result of the determination output from the order request command sensing unit and to determine whether the cartridge order information is stored in a predetermined memory associated with the image forming apparatus;
an order request information generating unit to receive a result of the determination output from the order information detecting unit, to detect a type and number of the cartridges to be ordered, and to generate the order request information from the cartridge order information; and
an information transmitting unit to receive the order request information output from the order request information generating unit and to transmit the generated order request information to the cartridge provider.

22. The apparatus of claim 16, further comprising:
an order information initializing unit to initialize the cartridge order information once the order request information is transmitted to the cartridge provider.

23. An apparatus to manage orders for replacement cartridges usable with an image forming apparatus, comprising:
a toner amount determination unit to determine whether at least one cartridge in the image forming apparatus should be replaced; and
an order information management unit to read identification information about the at least one cartridge from at least one cartridge memory associated with the at least one cartridge and to compile an order request having the read identification information about each of the at least one cartridge that should be replaced.

24. The apparatus of claim 23, further comprising:
an order request transmitting unit to transmit the compiled order request to a cartridge provider.

25. The apparatus of claim 23, wherein the order information management unit comprises:
an order information detecting unit to determine whether a list of cartridges to be ordered is stored in a memory associated with the image forming apparatus;
an order request information generating unit to generate the order request accordingly when the list of cartridges to be ordered is stored in the memory associated with the image forming apparatus; and
an information transmitting unit to transmit the order request to a cartridge provider.

26. The apparatus of claim 25, wherein the order request information generating unit generates the order request by categorizing cartridges on the list of cartridges to be ordered according to a cartridge type and counting a number of each cartridge type to be ordered.

27. The apparatus of claim 23, wherein the order information managing unit comprises an identification information storing unit to store a list of identification information of cartridges having toner that is consumed in a memory associated with the image forming apparatus.

28. The apparatus of claim 27, wherein the order information managing unit further comprises:
an order display information checking unit to determine whether order display information that corresponds to the at least one cartridge that should be replaced is stored in the corresponding at least one cartridge memory; and
an identification information checking unit to determine whether the identification information of the at least one cartridge that should be replaced is included in the list of identification information of cartridges having toner that is consumed when the order display information is not stored in the corresponding cartridge memory,
wherein the identification information storing unit stores the identification information about each of the at least one cartridge that should be replaced in the list of identification information of cartridges having toner that is consumed when the identification information of the at least one cartridge that should be replaced is not included in the list of identification information of cartridges having toner that is consumed.

29. An apparatus to automatically manage cartridge replacement orders for a plurality of cartridges installed in an image forming apparatus, comprising:
a toner amount sensor to determine one or more cartridges installed in the image apparatus that are low on toner;
an order information management unit to read cartridge identification information of the determined one or more cartridges that are low on toner from corresponding one or more cartridge memories; and
an order transmitting unit to transmit an order request for one or more replacement cartridges including the cartridge identification information read from the one or more cartridge memories of the one or more cartridges that are low on toner.

30. The apparatus of claim 29, wherein the order transmitting unit transmits the order request to a cartridge provider over a network.

31. A computer readable medium containing executable code to manage ordering of cartridges in an image forming apparatus, the medium comprising:
a first executable code to manage cartridge order information that includes cartridge identification of each cartridge to be ordered; and
a second executable code to generate order request information of cartridges to be ordered using the cartridge order information and to transmit the order request information to a cartridge provider.
